(19) United States
(12) Patent Application Publication
(10) Pub. No.: US 2017/0221465 A1
(43) Pub. Date: Aug. 3, 2017

(54) METHOD AND DEVICES FOR CONTROLLING FUNCTIONS EMPLOYING WEARABLE PRESSURE-SENSITIVE DEVICES

(71) Applicant: GREGORY A. PICCIONELLI, Westlake Village, CA (US)

(72) Inventor: GREGORY A. PICCIONELLI, Westlake Village, CA (US)

(73) Assignee: GREGORY A. PICCIONELLI, WESTLAKE VILLAGE, CA (US)

(21) Appl. No.: 15/230,100

(22) Filed: Aug. 5, 2016

Related U.S. Application Data
(63) Continuation-in-part of application No. 13/815,824, filed on Mar. 15, 2013.
Application No. 13/815,824 is a continuation-in-part of application No. 13/815,763, filed on Mar. 15, 2013, now Pat. No. 9,553,963.
(60) Provisional application No. 62/201,393, filed on Aug. 5, 2015.
(60) Provisional application No. 62/201,486, filed on Aug. 5, 2015.

(51) Int. Cl. G10H 1/34; G10D 3/16; G10H 1/00; H04B 1/034

(52) U.S. Cl. CPC G10H 1/34; H04B 1/0343; G10D 3/163; G10H 1/0008; G10H 2220/331; G10H 2220/096; G10H 2240/211

(57) ABSTRACT

A wearable pressure sensor coupled to a controller and transmitter/receiver that when activated sends a control signal.

### RELATED APPLICATIONS

This application claims priority to U.S. Provisional Application Ser. No. 62/201,393, titled “METHODS AND DEVICES FOR CONTROLLING FUNCTIONS EMPLOYING WEARABLE PRESSURE-SENSITIVE DEVICES,” filed on Aug. 5, 2015 and incorporated by reference herein; this application also claims priority to U.S. Provisional Application Ser. No. 62/201,486, titled “FINGER COMPUTER DISPLAY AND CONTROLLER DEVICE,” filed on Aug. 5, 2015 and incorporated by reference herein; this application also claims priority to U.S. patent application Ser. No. 13/815,824 (attorney docket 39003.836U502, entitled “COMPOSITION PRODUCTION WITH AUDIENCE PARTICIPATION,”) filed Mar. 15, 2013; this application also claims priority to U.S. patent application Ser. No. 13/815,763, titled “WRIST PHONE,” filed Mar. 15, 2013, that incorporated by reference U.S. Provisional Application Ser. No. 61/849,982, titled “FINGERNAIL SCREEN,” filed on Feb. 5, 2013, all of which are incorporated by reference herein.

### FIELD OF THE INVENTION

The present invention relates to methods of controlling functions, such as functions of electronic devices or devices incorporating processors. The present invention relates more specifically to methods for producing music, for example instrumental or vocal music. The present invention also relates more specifically to methods of modifying particular notes or vocalizations.

### BACKGROUND OF THE INVENTION

Wearable devices that are configured to receive and/or transmit commands, display information, and otherwise process information, have begun to appear in various applications. One such application where such devices are potentially useful is in music production, more particularly live music production. Performers using electronic instruments, such as electric guitars, have at their disposal various methods of modifying one or more signals signal generated by such electronic instruments, such as by switching on or off signal effects. Similarly, such performers using remotely controlled recorders and other devices have at their disposal various methods of triggering and/or controlling one or more sound generating devices or other devices to produce accompaniment musical parts, sound effects, lighting effects, etc. Typically, such methods require the use of foot pedal switches, foot pedal dials, switches and dials on instruments (such as on an electric guitar), switches and dials on amplifiers, etc., and/or other control elements remote from the person of the performer.

A need exists for a method of modifying one or more signals signal generated by electronic instruments, such as by switching on or off signal effects, and for remotely triggering and/or controlling one or more sound generating devices and/or other devices to produce accompaniment musical parts, sound effects, lighting effects, etc that does not require the use of such remote pedals or dials. A need further exists to effectuate the foregoing by a musical instrument player using one or both hands that are simultaneously being used to play the musical instrument player's musical instrument. Similarly, a need exists to similarly provide the ability to effectuate such remote switching and other control ability to a person who's hands are simultaneously engaged in another activity, such as operating a computer, operating a motor vehicle, operating other equipment, giving a massage, providing medical treatment, etc.

A need also exists for a method that can be adapted for use by a vocalist to remotely control devices that modify a signal generated by a microphone used by a vocalist to capture and transmit vocalizations.

More generally, a need exists for methods for controlling the operation of devices, such as musical instruments, sound and/or light effect generators, and other electronic and/or electromechanical devices useful in various contexts including music production, the operation of computational and telecommunication devices, operation of surgical devices, operation of prosthetics, and more generally, any device having one or more components or functions that can be activated, de-activated and/or otherwise controlled upon receipt of an appropriate signal or command. A need also exists for an apparatus useful in carrying out such methods, more particularly a wearable apparatus, very particularly a finger-wearable apparatus.

### BRIEF DESCRIPTION OF THE DRAWINGS

The invention may be more readily understood by referring to the accompanying drawings in which:

FIG. 1 is an illustration of a pressure-sensitive finger ring remote controller according to embodiments of the invention;

FIG. 2 is an illustration of the transmission of a control signal from a pressure-sensitive remote controller ring as described herein to a receiver in communication with an external device, whereby such external device receives a signal from a musical instrument, such as an electric guitar, such external device effecting such signal and conveying such effected signal to an amplification means;

FIG. 3 is a schematic illustration of a guitar player's hand in proximity to the strings of an electric guitar, bearing on his fingers a plurality of pressure-sensitive finger ring remote controllers;

FIG. 4 is an illustration of use of a pressure-sensitive finger ring remote controller together with a guitar pick;

FIGS. 5a-c are profile, top plan and front end views of a pressure-sensitive finger ring remote controller combined with a guitar pick;

FIG. 6 is a side sectional view of a pressure-sensitive guitar pick remote controller useful in controlling functions;

FIG. 7 is an illustration of the use of multiple finger ring remote controllers with multiple external devices;

FIG. 8 is an illustration of an alternative finger ring remote controller including a touch screen disposed on or in a portion of the outer surface of the ring body, which provides an alternative mechanism for activating the finger ring remote controller;

FIGS. 9a-b are illustrations of an alternative “wrap around” finger ring remote controller that includes a flexible ring body that is securable around the finger of a wearer;

FIGS. 10a-b are illustrations of an alternative implementation of a “wrap around” finger ring remote controller provided with fastening elements, which enable a plurality of such finger ring remote controllers to be secured together for easy storage and transport, in very particular embodiments after such finger ring remote controllers have been substantially flattened out;

FIGS. 11a-c are illustrations of alternative control devices useful in place of, or in combination with, one or more finger ring remote controllers, in which the control device is a finger computer display and control device (“FCDCD”);

FIG. 12 is an illustration of a method of using an embodiment of a finger ring remote controller according to the invention with one or more additional wearable devices; and

FIGS. 13a-c are illustrations of the use of two finger ring remote controllers, each provided with a touch screen, to control a function of a sound effect by a performer.

Like numerals refer to like parts throughout the several views of the drawings.

### DETAILED DESCRIPTION OF THE PREFERRED EMBODIMENTS

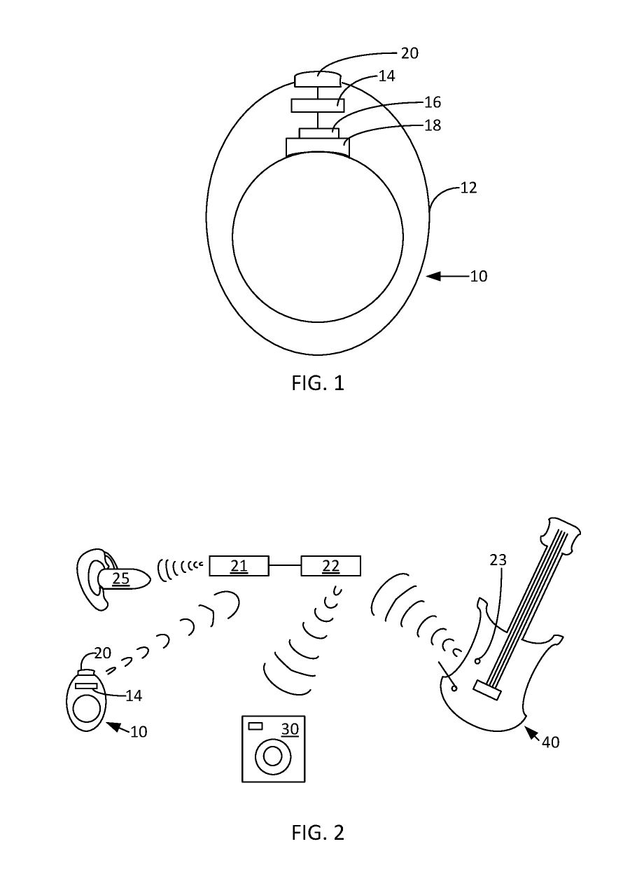

Referring to FIG. 1, in a first embodiment of an apparatus useful in practicing methods according to the invention, finger ring remote controller 10 includes ring body 12 within which is disposed one or more transmitters 14 powered by one or more batteries 16. In some embodiments, removable cover 18 allows access to battery(ies) 16. Pressure-sensitive switch 20 communicates with transmitter 14 that transmits a control signal.

In certain particular embodiments, additional computer circuitry in communication with transmitter(s) 14 is included within ring body 12. Exemplary additional computer circuitry includes, without limitation, processors, signal receivers, and digital content storage elements.

When pressure-sensitive switch 20 is depressed, it activates transmitter 14. Transmitter 14 in turn transmits a control signal to a receiver/control signal relay device 21 that relays the control signal to a source signal modifying external device 22 controlled by the control signal, and which external device is also in communication (e.g., via an appropriate transmitter 23, cable connection, etc.) with a source signal generated by an electronic musical instrument (e.g., electric guitar 40) or microphone such that such source signal modifying external device can receive and modify the source signal, and such external device further configured to output the modified source signal to a second external device, such as amplification means 30 (internal circuitry not shown), as shown in FIG. 2. The control signal controls the source signal modifying external device to engage functionality therein that activates a modification of the source signal generated by the electronic instrument or microphone. Exemplary modifications effectuated by the external source signal modifying device include, without limitation, one or more of the following: delay, distortion, amplifier simulations, guitar simulations, reverb, chorus, sampling, wah-wah, and variations thereof. In some embodiments, the control signal controls one or more other types of external devices, such as devices that generate, store, and/or play loops, samples, recordings, source signal modifications, MIDI files, or other data files, devices that control lights, light effects, special effects, video capture, mixing boards, audience telecommunication devices, and virtually any other types of devices that can be remotely controlled though the use of a control signal received from a receiver/control signal relay or the control signal received from transmitter 14 of finger ring remote controller 10 or by the control signal received from transmitter 14 of finger ring remote controller 10 directly.

Pressure-sensitive finger ring remote controllers 10 can be worn singly, or a plurality of such rings can be worn, allowing the performer to generate a variety of controls of one or more external devices.

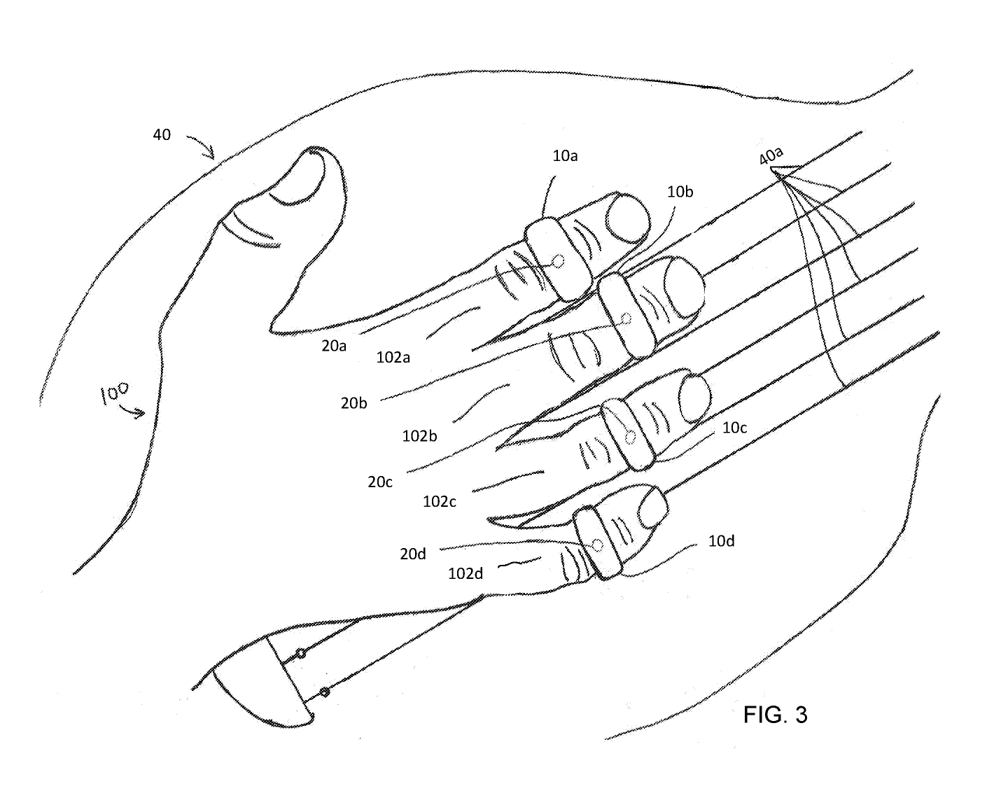

With reference to FIG. 3, a method of producing music employing pressure-sensitive finger ring remote controller according to the invention will be described. Electric guitar 40, having guitar strings 42, is played by a guitarist. The hand 100 of the guitarist bears a plurality of pressure-sensitive finger ring remote controllers 10a-d on fingers 102a-d, respectively. Finger ring remote controllers 10a-d are worn on the guitarist's fingers, in certain embodiments, such that pressure-sensitive switches 20a-d are positioned facing upward on top of the finger so that such switches can be depressed by crossing an adjacent finger over the top of the finger with such upward-facing switch. The positioning and orientation of finger ring remote controllers 10a-d on the guitarist's fingers is a matter of the guitarist's preference. Some guitarists may prefer to wear some or all finger ring remote controllers over the fingernail or between the fingertip and the first knuckle; others may prefer positioning between the first and second knuckles; still others may prefer various positions depending on playing style, finger size, personal comfort, or other considerations. Similarly, the orientation of one or more of the pressure-sensitive switches may be varied by the user.

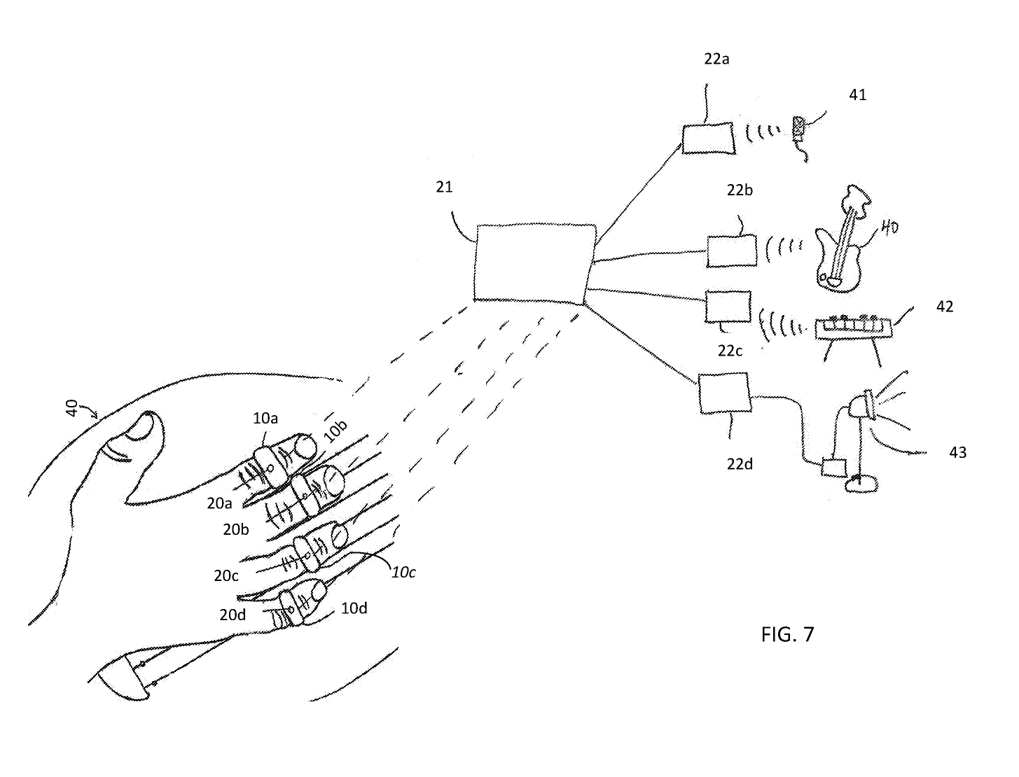

In using devices according to various of the foregoing embodiments, the guitarist strums one or more strings 40a of electric guitar 40. For example, in some embodiments, when the guitarist desires to produce unmodified (e.g. “clean”) notes or sound, the guitarist does not activate any of pressure-sensitive switches 20a-d. When the guitarist desires to produce a modified note or sound, he or she causes one of his or her fingers to depress and activate the desired pressure-sensitive switch on one of rings 10a-d (see FIG. 7, as illustrated, ring 10b) to send a control signal to one or more external devices that is (are) in communication with the source signal being generated by the guitarist's electric guitar, which control signal then effects or otherwise modifies the source signal. Depressing the pressure-sensitive switch, activates the ring's transmitter and causing a control signal to be sent to a receiver in communication with (1) one or more external devices in communication with the source signal generated by electric guitar 40, a microphone 41 or other device, to engage functionality in such one or more external devices to effectuate a modification of the source signal produced by the guitar 40, microphone or other device, or (2) one or more external devices that trigger the activation of one or more sound or signal generating devices, sound or signal modifying devices, synthesizers (e.g., keyboard 42), light controllers (e.g., lighting system 43), special effects controllers, a functionality of a “Collaborative Show Performance System” as that term is used in U.S. patent application Ser. No. 13/815,824 (attorney docket 39003.836U502), filed Mar. 15, 2013 to Gregory A. Piccionelli, entitled “Composition Production with Audience Participation” that is incorporated by reference herein, or some other function of a device configured to receive a control signal from one or more finger ring remote controllers.

In some embodiments a plurality of finger ring remote controllers can be configured to generate a plurality of different wireless signals that can control a plurality of external devices used by a musician to modify a signal produced by the musician's electronic instrument and/or a plurality of function of one or more external devices. Thus, in some embodiments, if the signal produced by an electric guitar is in communication with a plurality of external devices that each effect the source signals produced by the electric guitar to produce a first effect, such as delay, a second effect, such as reverb, a third effect, such as distortion, a fourth effect, such as a selected amplifier model, and a fifth effect, such as the playing of a loop or recording, ring remote controller 10a switches on and off the first effect, ring 10b switches on and off the second effect, ring 10c switches on and off the third effect, and ring 10d switches on and off the fourth effect, by each of the aforesaid ring controllers generating a separate wireless control signal in communication with one or more receivers in communication with such external devices.

In some embodiments, to conserve power consumption by the ring remote controllers, one or more ring remote controllers make use of a near-field wireless communication device 25 (see FIG. 2), such as a Bluetooth device, to send one or more signals from one or more ring remote controllers to a control signal receiver/relay hub that, in turn, relays the one or more control signals to a second receiver in communication with one or more devices. In some embodiments, the control signal receiver/relay hub is configured to be worn by a musician.

Various embodiments of the foregoing ring remote controller 10 communicate by wire or wirelessly with components internal to an instrument being played, or external to an external device. Thus, various embodiments of ring 10 communicate with, and effectuate control over one or more components inside an electric guitar or other device, components inside an acoustic guitar configured with controllable electronics (e.g., microphone or pickup controls, on board tuners, etc.), components inside a keyboard, or components inside another type of instrument. Thus, in some embodiments, a guitarist can use a ring remote controller to switch guitar pickups on or off, etc., if the guitar's circuitry is configured to receive such control signals and effectuate such pickup control in response.

In some embodiments, the finger ring remote controller switches can be used to control one or more external effects pedals, stage lighting systems, sound systems, or any other external device whose function(s) can be altered in response to an activation or deactivation of a control signal.

In some embodiments, the switch used by the finger ring remote controller is a binary on-off switch. In some embodiments, however the switch is a multi-function switch with a plurality of switch positions that effectuates a plurality of separate control signals in association with such plurality of switch positions. For example, in some embodiments, the switch is a binary switch that sends an “on” control signal when it is first depressed and an “off” control signal when it is next depressed. In some embodiments, the switch is a multi-step switch where steps 1 through n generate control signals 1 through n.

In various particular embodiments, appropriate programming of one or more external devices is(are) employed to effectuate the separate control of one or more external devices, and/or different functions in one or more external devices.

In some embodiments, one finger ring remote controller 10 can be used, to control one or more external devices to revert to a previous state, such as an “all effects off” state.

Alternative embodiments of methods according to the invention dispense with the need for a device external to a musical instrument being played by a musician use the finger ring remote controller(s). In such embodiments, amplification and/or sound generation is produced by the instrument itself, and the instruction from transmitter 14 is provided directly to the instrument.

The finger ring remote controllers according to various embodiments of the invention can also be used by vocalists to control effect devices and other external devices that affect a source signal generated by a microphone the vocalist is using capture and relay the vocalist's performance. In some such embodiments, for example, one or more finger ring remote controllers 10 can be worn by a vocalist, being positioned as described above with respect to FIG. 2, or alternatively, positioned such that each ring's pressure-sensitive switch extends downward from the vocalist's fingers. In the latter embodiments, a vocalist can grip an object, such as a microphone, contact a solid surface such as a piano, or the like, in order to activate specific finger ring remote controllers at desired times. Using the finger ring remote controllers according to various embodiments of the invention, vocalists can modify the vocalizations they provide via a microphone (e.g., hand-held wired or wireless) in source signal communication with one or more source signal modifying external devices controlled via one or more of the finger ring remote controllers. They can also, in very specific embodiments, control or cause production of accompaniment for their vocalizations, through control of one or more external devices that generate or otherwise play such accompaniment, prerecorded music files, sound files, synthesizer programs, etc.

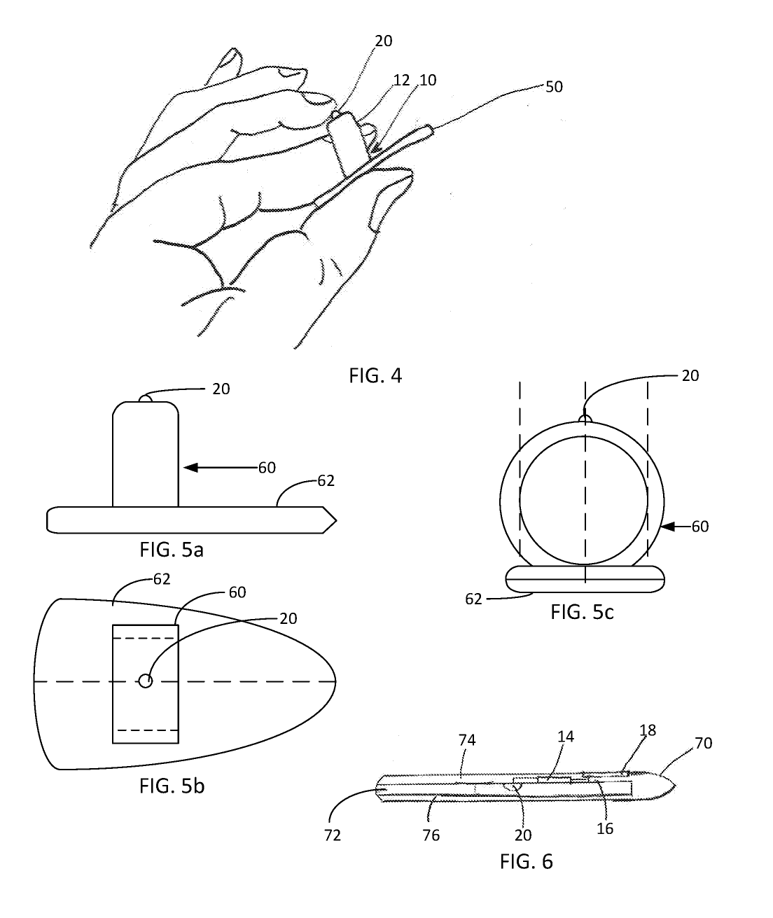

In some embodiments, a guitarist can also grasp a pick 50 between his thumb and index finger while wearing a finger ring remote controller 10 on his index finger (FIG. 4). Additional embodiments of devices according to the invention useful for the production of music are illustrated in FIGS. 5a-c and 6. In FIGS. 5a-c, finger ring remote controller 60 is integral with pick 62. Such integral embodiments reduce slippage between finger ring remote controllers and picks. In FIG. 6, pick 70 itself incorporates pressure-sensitive switch 20 in communication with internally-disposed transmitter 14 powered by battery 16, which, in some embodiments are accessed by removable cover 18. Within pick 70 is defined space 72 between upper wall 74 and lower wall 76; space 72 allows for motion of pressure-sensitive switch 20 in response to pressure exerted by the grip of the guitarist on pick 70. When sufficient pressure is exerted on pick 70 to compress upper wall 74 and lower wall 76 together, pressure-sensitive switch 20 contacts lower wall 76, thus activating transmitter 14 in a manner similar to the preceding embodiments. Pick 70, in particular embodiments, is formed from a material that is sufficiently rigid to facilitate picking of strings 42, yet flexible enough to enable activation of pressure-sensitive switch 20 in the manner described above. Non-limiting exemplary materials include plastics such as celluloid, nylon, ACETAL™, ULTEM™, LEXAN™, various acrylics, DELREX™ and the like, as well as metals and woods.

Embodiments of the inventive methods and wearable devices are not limited to the context of music production. In alternative embodiments of methods according to the invention, wearable devices similar to the finger ring remote controllers described above are used to control one or more functions of devices including, without limitation, a telecommunication device, a personal computer, a television set, a radio or stereo, a household or commercial appliance that includes a processor configured to accept wireless transmissions, etc. Non-limiting examples of such devices include those described in U.S. Provisional Patent Application Ser. No. 61/815,982 (attorney docket no. 39003.853USP1), entitled “Wrist Phone”, to Gregory A. Piccionelli, filed Mar. 15, 2013, and those described in U.S. Provisional Patent Application No. 61/849,982 (attorney docket 39003.851USP1), filed Feb. 5, 2013, to Gregory A. Piccionelli, entitled “Finger Computer Display and Controller Device”, the entire disclosures of which are incorporated herein by reference as if fully set forth herein. Here, a “telecommunication device” denotes any device capable of accessing a telecommunication network and transmitting and/or receiving data via a network so accessed, and includes, without limitation, cellular telephones, smart phones, portable computing devices, including without limitation devices adapted to be worn by a user and capable of accessing a telecommunication network, etc.

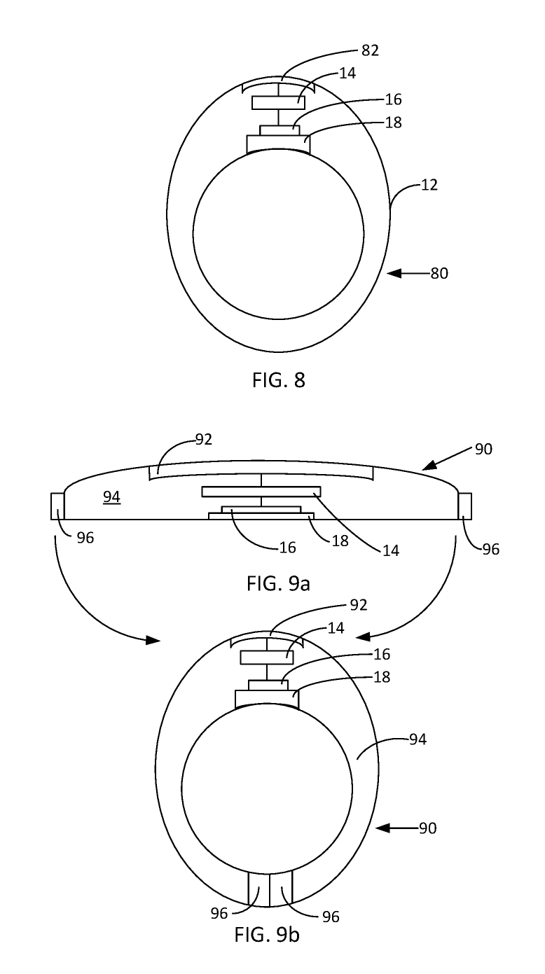

In some embodiments, a finger ring remote controller includes a touch screen. As shown in FIG. 8, touch screen 82 disposed on an upper surface of ring body 12 communicates with transmitter 14. Activation of touch screen 82, e.g., by a user's finger, activates transmitter 14 in a manner similar to activation of pressure-sensitive switch 20 in various embodiments described previously.

In further alternative embodiments, a finger ring remote controller comprises a flexible ring body. An example of such a “wrap-around” embodiment is illustrated in FIGS. 9a-d. Finger ring remote controller 90 includes flexible screen 92 disposed on flexible ring body 94. Securing elements, such as magnetic clasps 96, secure finger ring remote controller 90 about a user's finger.

In such embodiments, flexible screen 92 can comprise an OLED screen, such as that produced by Samsung. Other flexible screens can also be employed. Flexible ring body 94 can comprise, in various embodiments, a polymer; a plurality of connected links; or other flexible materials. Suitable structures and fabrication methods useful for producing finger ring remote controllers 90 according to embodiments of the invention are described in U.S. Provisional patent application Ser. No. 13/815,763 (attorney docket no. 39003.853USP1), filed Mar. 15, 2013, entitled “Wrist Phone”, to Gregory A. Piccionelli, suitably scaled to the size of a device configured to fit around a user's finger rather than wrist. In such embodiments, flexible screen 92 is disposed on an outer surface of flexible ring body 94 rather than an inner surface.

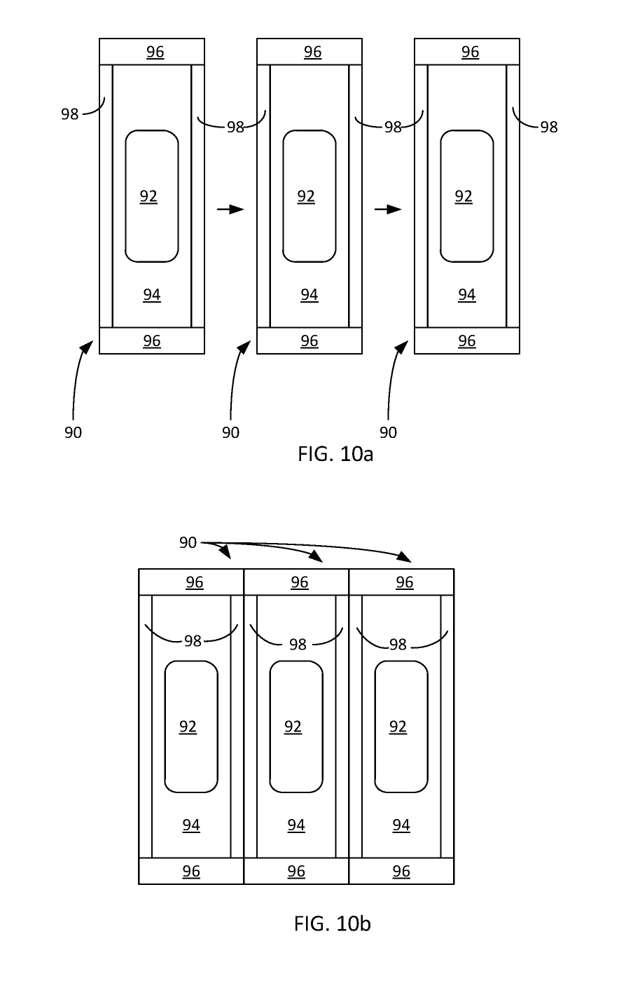

In certain embodiments, flexible finger ring remote controllers are provided with coupling or connecting elements, such as magnetic strips, mechanical elements such as snaps, etc., that enable a plurality of flexible finger ring remote controllers to be secured together for convenient storage and transport. In FIGS. 10a-b, flexible finger ring remote controllers 90 are provided with flexible magnetic strips 98. Flexible finger ring remote controllers 90 are substantially flattened, and then placed adjacent each other such that flexible magnetic strips 98 of adjacent flexible finger ring remote controllers are brought in to contact and are magnetically secured to each other. The conjoined flexible finger ring remote controllers are now configured for convenient storage and/or transport.

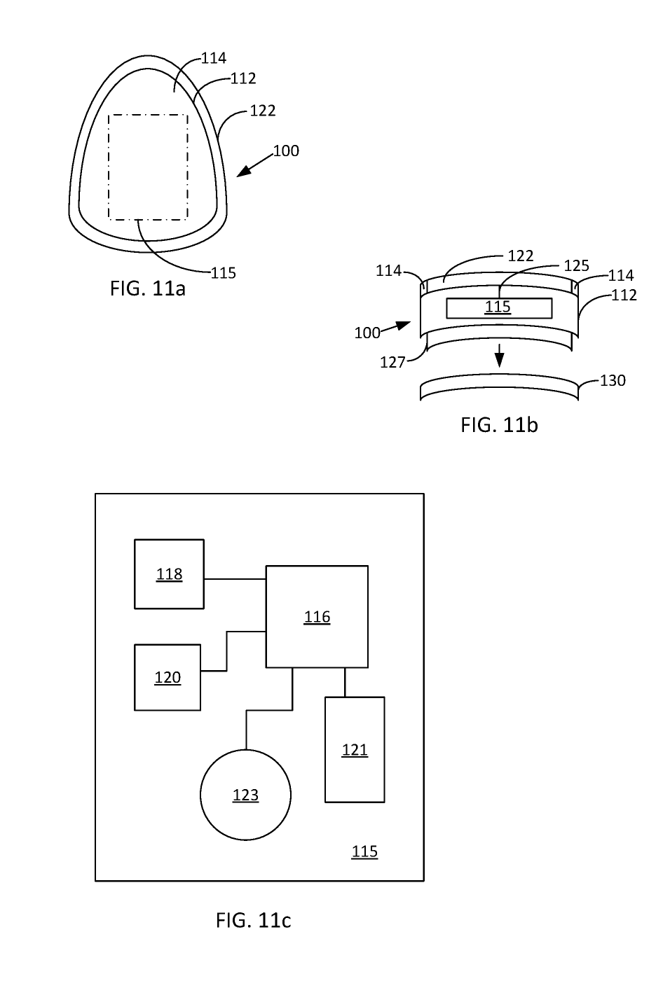

It is to be understood that the control of external devices as described above by means of embodiments of the inventive finger ring remote controller can be effectuated in a similar way by the engagement of one or more devices mounted on one or more of a user's fingernails. Examples of such devices are described in U.S. Provisional Patent Application No. 61/849,982 (attorney docket 39003.851USP1), filed Feb. 5, 2013, to Gregory A. Piccionelli, entitled “Finger Computer Display and Controller Device”, the entire disclosure of which is incorporated herein by reference. In some embodiments of the present invention, the finger computer display and controller devices (“FCDCD's”) disclosed in the foregoing patent applications may be configured with the same types of switch and controller functionality (including touch screens), controller signal transmission functions, and other functions associated with the finger ring controllers described herein. Non-limiting examples of such FCDCD's are illustrated in FIGS. 11a-c. Thus, exemplary FCDCD 100 includes a case 112, in which is included a screen upper layer 114, which in some embodiments is a flexible screen, computer circuitry 115 including a processor 116, a signal receiver 118, a signal transmitter 120, digital content storage element 121, and battery 123. Screen upper layer 114 has defined therein display area 122. In some embodiments other components commonly included in a telecommunications device, such as an Apple iPhone® 5 or a Samsung Galaxy® IV smart phone may also be included in the case. Adhesive layer 127 releasably secures case 112 to a human fingernail or, in alternative embodiments (see FIG. 11b), to artificial nail 130. Processor 116 communicates with screen upper layer 114 via lead 125, enabling processor 116 to control the operation of screen upper layer 114 and to produce images in display area 122 of screen upper layer 114.

Such FCDCD's can be utilized together with the wearable and/or graspable devices disclosed herein to afford control over multiple functions of various devices. Such FCDCD's can be powered, or in more specific embodiments, jointly powered by use of various configurations of batteries, thermoelectric materials, and other power supplying configurations as described in U.S. Provisional Patent Application No. 61/849,982 (attorney docket 39003.851USP1), filed Feb. 5, 2013, to Gregory A. Piccionelli, entitled “Finger Computer Display and Controller Device”, the entire disclosure of which is incorporated herein by reference. Such FCDCD's configured with touch screen control functionality may be configured with one or more applications to transmit one or more control signals in response to touch screen engagement of such application or related function(s) by, for example, the user's tapping on the fingernail touch screen

Thus, in some embodiments the functions of finger ring remote controllers (i.e., device function switching and other function control) is effectuated by a touch screen configured FCDCD mounted on one or more fingernails.

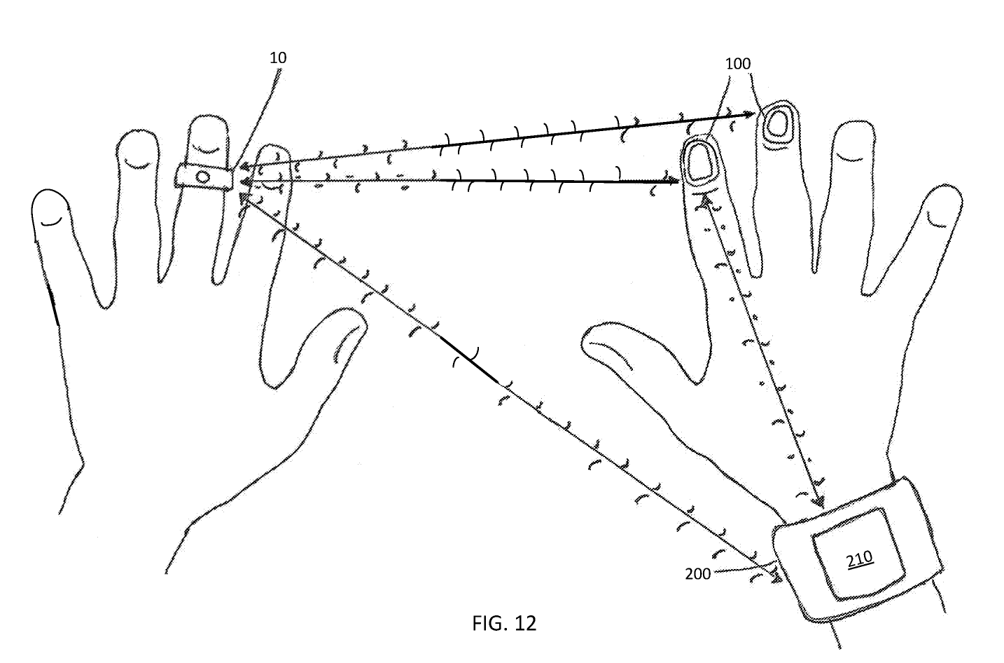

Embodiments of finger ring remote controllers as described herein can be beneficially employed in conjunction with one or more FCDCD's and/or wrist phones. A schematic illustration of the interactions among a finger ring remote controller 10 with a plurality of FCDCD's 100, and a wrist phone 200 (as illustrated, with upper screen 210), is presented in FIG. 12. Transmissions between two or more of the illustrated units, as well as transmissions received from external sources, such as, without limitation, telecommunication devices, computers, heads-up displays such as Google Glass units worn by the user of devices 100, 100 and 200 or by other users, and finger ring remote controllers and/or FCDCD's worn or operated by other users, afford control of various functions of the devices 10, 100 and 200.

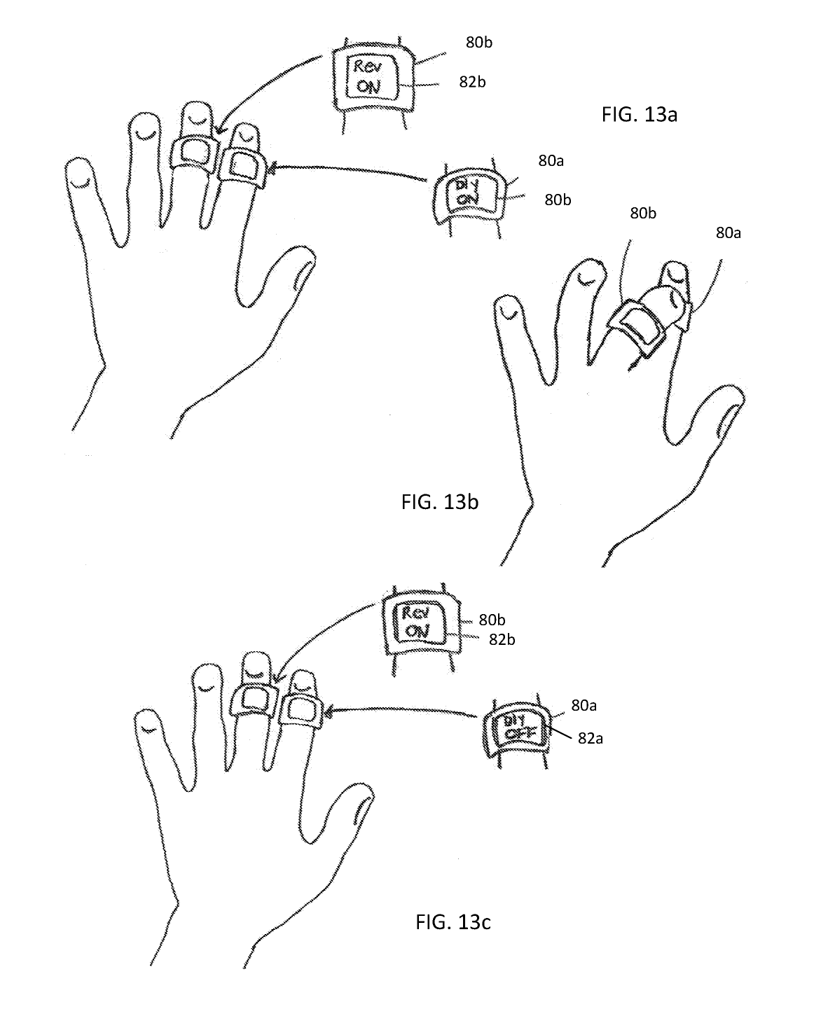

FIGS. 13a-c illustrate the use of two finger ring remote controllers (as illustrated, finger ring remote controllers provided with touch screens) to control a sound effect. In FIG. 13a, a user wears two finger ring remote controllers 80a, 80b, each provided with touch screen 82a, 82b as described previously. Finger ring remote controller 80a is configured to control a first effect, as illustrated a delay effect associated with a musical instrument, such as an electric guitar. Finger ring remote controller 80b is configured to control a second effect, as illustrated a reverberation effect associated with the musical instrument. Both effects are currently in operation, and thus, the respective finger ring remote controllers 80a, 80b associated with each effect displays a message to that effect on respective touch screens 82a, 82b (as shown, “Dly ON” and “Rev ON”).

In FIG. 13b, the user's middle finger crosses over the index finger, and contacts touch screen 82a of finger ring remote controller 80a. The contact causes a signal to be transmitted (for example, in a manner similar to that described in FIG. 2) that results in deactivation of the delay function associated with the electric guitar. When the delay function has been deactivated, touch screen 82a of finger ring remote controller 80a now displays the message “Dly OFF”, while touch screen 82b of finger ring remote controller 82a continues to display “Rev ON.”

In some further preferred embodiments, when pressure-sensitive switch 20 is depressed, it activates transmitter 14 which transmits a control signal to an external device configured with a receiver and means to use the control signal to control one or more functions of the external device. Such embodiments can be practiced in a wide variety of circumstances, not limited to musical performances. For example, in certain particular embodiments, a surgeon is provided with a finger ring remote controller 10 that communicates with a retractor equipped with a signal receiver, a processor, an actuator activated by a control signal from the processor, and other appropriate circuitry and electromechanical components. During surgery, the surgeon makes an incision with a scalpel, then deploys a retractor as described above. By activating a pressure-sensitive switch 20 on finger ring remote controller 10, the surgeon causes an instruction to be transmitted to the retractor that causes the retractor to open, maintaining the incision in a retracted state. A subsequent activation of pressure-sensitive switch 20 causes the retractor to close, allowing withdrawal of the retractor and closure of the incision. In additional particular embodiments, the surgeon is enabled to activate other external devices needful or useful during surgery.

Security features are included in various particular embodiments of devices according to the invention. In certain embodiments, finger ring remote controller 10 communicates with an external device, such as a personal computer, a wearable telecommunication device, etc., encoded with a voice-recognition system. A wearer of finger ring remote controller 10 provides a name, password or other vocal response in response to a query from the voice-recognition system when the wearer first attempts to utilize finger ring remote controller 10 by depressing pressure-sensitive switch 20. Provision of the proper vocal response enables use of finger ring remote controller 10 to control some or all functions or a device or devices which are configured to receive signals from transmitter 14 of finger ring remote controller 10. Multiple passwords or other vocal responses can be required, in certain specific embodiments, in order to enable control of various functions or sets of functions of one or more devices.

Various wearable and/or graspable devices useful according to the invention, including without limitation finger ring remote controllers configured with one or more mechanical pressure switches, finger rings configured with one or more touch screen means of engaging the device's switches and/or other functions, fingernail-mounted touch screen controller devices, pick controllers, combination finger ring remote controller/picks, and combination fingernail-mounted touch controller/picks, are powered, in certain embodiments, by appropriately-sized batteries. In other particular embodiments, wearable and/or graspable devices are powered by RF inductor technology, in a manner similar to “smart cards”; such embodiments function best in environments having a continuous supply of RF signals. In still other embodiments, electricity generated from a thermoelectric material such as Power Felt in contact with a user's body provides sufficient current to operate the inventive devices. Depending on the efficiency of the thermoelectric material and the current requirements of various embodiments of wearable and/or graspable devices according to the invention, a beneficially utilized power supply can take the form of, for example, a band of thermoelectric material positioned around a user's finger and in communication with, e.g., finger ring remote controller 10 via appropriate conductors, contacts, and electronic components regulating current flow. Alternatively, a glove of thermoelectric material, in very particular embodiments, provides electricity to a plurality of finger ring remote controllers and/or other wearable or graspable devices.

Such alternative power supplies are compatible with various additional devices, including as non-limiting examples the FCDCD's described in U.S. Provisional Patent Application No. 61/849,982 (attorney docket 39003.851USP1), filed Feb. 5, 2013, to Gregory A. Piccionelli, entitled “Finger Computer Display and Controller Device”, the entire disclosure of which is incorporated herein by reference. FCDCD's disclosed in the foregoing patent applications can be utilized together with the wearable and/or graspable devices disclosed herein to afford control over multiple functions of various additional devices, and can be separately powered, or in more specific embodiments, jointly powered by use of various configurations of thermoelectric materials as described above.

It will be understood, and is appreciated by persons skilled in the art, that one or more processes, sub-processes, or process steps described in connection with the figures may be performed by hardware and/or software (machine readable instructions) that configures generic hardware to perform a specific function. If the approach is performed by software, the software may reside in software memory (not shown) in a suitable electronic processing component or system such as one or more of the functional components or modules schematically depicted in the figures.

The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any tangible means that may contain or store the program for use by or in connection with the instruction execution system, apparatus, or device. The tangible computer readable medium may selectively be, for example, but is not limited to, an electronic, magnetic, optical, electromagnetic, infrared, or semiconductor system, apparatus or device. More specific examples, but nonetheless a non-exhaustive list, of tangible computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the computer-readable medium may even be paper (punch cards or punch tape) or another suitable medium upon which the instructions may be electronically captured, then compiled, interpreted or otherwise processed in a suitable manner if necessary, and stored in a computer memory.

The foregoing detailed description of one or more embodiments of the approach for controlling functions employing wearable pressure sensitive devices has been presented herein by way of example only and not limitation. It will be recognized that there are advantages to certain individual features and functions described herein that may be obtained without incorporating other features and functions. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein.

1. A wearable controller, comprising:
a power supply;
a transmitter coupled to the power supply;
a sensor; and
a processor coupled to the power supply and the transmitter associated with a housing where the housing is adapted to be worn on a finger and a signal be generated in response to the senor.

2. The wearable controller of claim 1, where the sensor is a pressure sensor.

3. The wearable controller of claim 2, where the pressure sensor generates the signal when pressure is applied to the pressure sensor.

4. The wearable controller of claim 1 where the transmitter transmits another signal in response to the signal from the sensor.

5. The wearable controller of claim 1 where the other signal is adapted for receipt of a controller hub.

6. The wearable controller of claim 5, where the controller hub is able to receive a plurality of other signals from a plurality of transmitters with each of the other signals being identified to only one of the plurality of transmitters.

7. The wearable controller of claim 5, where the controller hub is in a musical interment.

8. A wearable controller system, comprising:
a power supply;
a transmitter coupled to the power supply;
a sensor;
a processor coupled to the power supply and the transmitter associated with a housing where the housing is adapted to be worn on a finger and a signal be generated in response to the senor; and
a controller hub having a receiver in receipt of a signal from the transmitter.

9. The wearable controller of claim 8, where the sensor is a pressure sensor.

10. The wearable controller of claim 10, where the pressure sensor generates the signal when pressure is applied to the pressure sensor.

11. The wearable controller of claim 8 where the transmitter transmits another signal in response to the signal from the sensor.

12. The wearable controller of claim 8 where the other signal is adapted for receipt by the controller hub.

13. The wearable controller of claim 12, where the controller hub is able to receive a plurality of other signals from a plurality of transmitters with each of the other signals being identified to only one of the plurality of transmitters.

14. The wearable controller of claim 12, where the controller hub is in a musical interment.

15. A method for a wearable controller, comprising:
generating electrical power from a power supply;
receiving electrical power at a transmitter coupled to the power supply;
receiving electrical power at a sensor; and
generating a signal by a processor coupled to the power supply and the transmitter associated with a housing where the housing is adapted to be worn on a finger and in response to the senor.

16. The method for a wearable controller of claim 15, where generating a signal further includes applying pressure to the sensor which is a pressure sensor.

17. The method for a wearable controller of claim 15 includes, transmitting with the transmitter another signal in response to the signal from the sensor.

18. The method of wearable controller of claim 15, where the other signal is adapted for receipt for a controller hub.

19. The method for wearable controller of claim 18 further includes, receiving at the controller hub a plurality of other signals from a plurality of transmitters with each of the other signals being identified to only one of the plurality of transmitters.

20. The method for a wearable controller of claim 18, includes securing the controller hub in a musical interment.
